(19) United States
(12) Patent Application Publication
(10) Pub. No.: US 2014/0169138 A1
(43) Pub. Date: Jun. 19, 2014

(54) APPARATUS AND METHOD FOR REPELLING PESTS IN GREENHOUSE

(71) Applicant: Electronics and Telecommunications Research Institute, Daejeon-si (KR)

(72) Inventors: Hae-Dong LEE, Daegu-si (KR); Kyu-Hyung Kim, Daegu-si (KR); Soo-In Lee, Daejeon-si (KR)

(21) Appl. No.: 13/940,764

(22) Filed: Jul. 12, 2013

(30) Foreign Application Priority Data
Dec. 14, 2012 (KR) 10-2012-0146415

(51) Int. Cl. A01M 29/18; A01M 1/24

(52) U.S. Cl. CPC A01M 29/18; A01M 1/24
USPC 367/139; 43/2

(57) ABSTRACT

Provided is a method for repelling pests from a greenhouse which is open and closed by a vent, and the method includes recognizing a pest which lives in or may possibly come into a greenhouse, detecting a frequency required to repel the recognized pest; and emitting an ultrasonic wave or attractant light with the detected frequency.

### CROSS-REFERENCE TO RELATED APPLICATION

This application claims the benefit under 35 U.S.C. §119(a) of Korean Patent Application No. 10-2012-0146415, filed on Dec. 14, 2012, in the Korean Intellectual Property Office, the entire disclosure of which is incorporated herein by reference for all purposes.

### BACKGROUND

1. Field

The following description relates to an apparatus and a method for repelling pests, and more particularly to a method for repelling pests which lives in or may possibly come into a greenhouse.

2. Description of the Related Art

Raising greenhouse crops, such as paprika, is economically advantageous for producers and is able in a mass production system. One of the most important things when planting greenhouse crops is to prevent the crops out of pests. To do this, many farmers facilitates pesticide, but the pesticide inevitably leads to economic and social costs like food contamination and environmental disruption. For this reason, a new technical method for repelling pests with less use of pesticide is needed. In other words, what is demanding is a environmental-friendly pest control method which would help increase crop production and minimize environmental pollution.

In particular, it is essential to accurately predict distribution and density of pests of crops for the purpose of reduced use of pesticide and efficient pest management. However, the related art pest repelling apparatus and method, designed to digitalize distribution and population of pests, fail to calculate an accurate density of pests and require relatively more manual works.

### SUMMARY

The following description relates to an apparatus and a method for repelling pests, which lives in or may possibly come into a greenhouse, by recognizing the pest.

In addition, the following description relates to an apparatus and a method for repelling pests by generating an ultrasonic wave making a pest annoyed or an attractant light favored by the pest to go out of the greenhouse.

Moreover, the following description relates to an apparatus and a method by which a vent of a greenhouse is able to be controlled for the efficiency in repelling pests.

In one general aspect of the present invention, a method for repelling pests from a greenhouse which is open and closed by a vent is provided, and the method includes recognizing a pest which lives in or may possibly come into a greenhouse, detecting a frequency required to repel the recognized pest; and emitting an ultrasonic wave or attractant light with the detected frequency.

In another general aspect of the present invention, an apparatus for repelling pests from a greenhouse is provided, and the apparatus includes a pest recognizing unit configured to recognize a pest which lives in or may possibly come into a greenhouse which is open and closed by a vent; an emitting unit; and a control unit configured to detect a frequency required to repel the recognized pest, and control the emitting unit to emit an ultrasonic wave or attractant light with the detected frequency.

Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating an apparatus for repelling pests from a greenhouse according to an exemplary embodiment of the present invention;

FIG. 2 is a diagram illustrating a configuration of a pest recognizing unit according to an exemplary embodiment of the present invention;

FIG. 3 is a diagram illustrating a configuration of a control unit according to an exemplary embodiment of the present invention; and

FIG. 4 is a flow chart illustrating a method for repelling pests from a greenhouse according to an exemplary embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will suggest themselves to those of ordinary skill in the art. Also, descriptions of well-known functions and constructions may be omitted for increased clarity and conciseness.

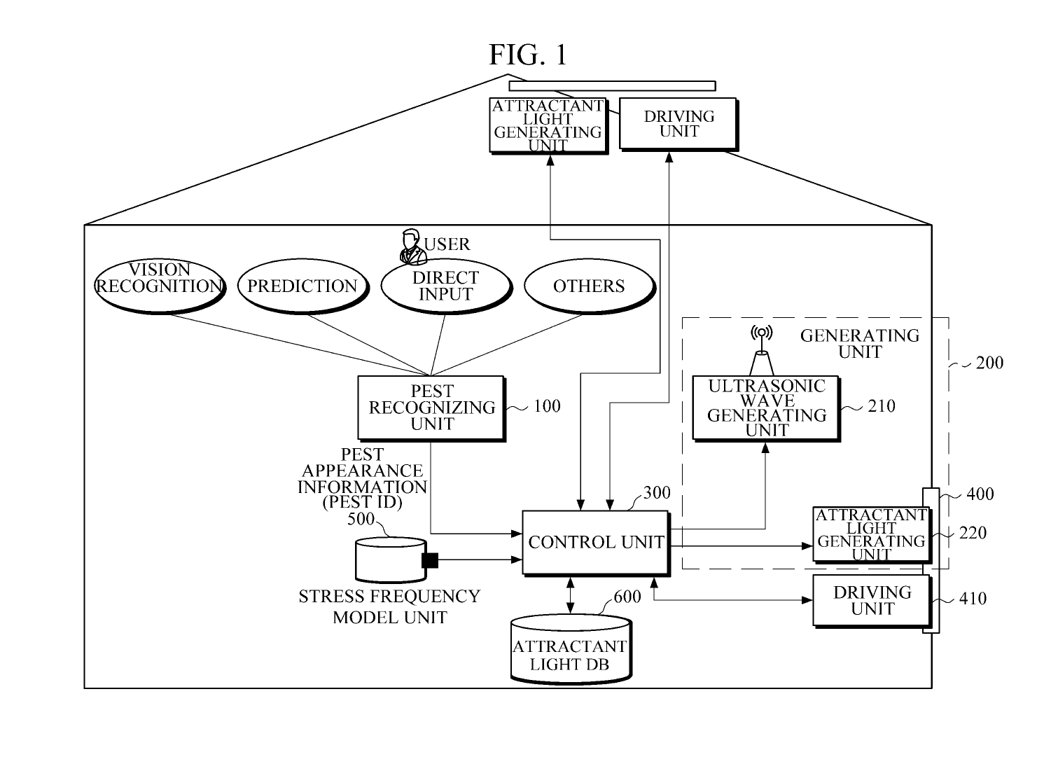

FIG. 1 is a diagram illustrating an apparatus for repelling pests from a greenhouse according to an exemplary embodiment of the present invention.

Referring to FIG. 1, the apparatus 100 for repelling pests from a greenhouse includes a pest recognizing unit 100, an emitting unit 200 and a control unit 300.

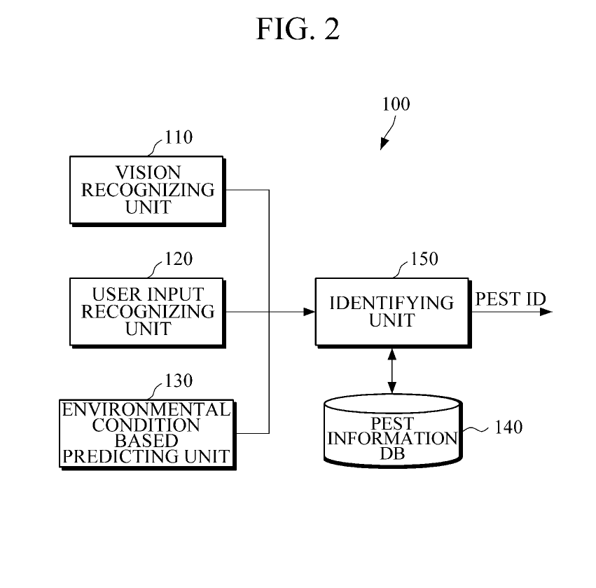

The pest recognizing unit 100 recognizes a pest which lives in or may possibly come into a greenhouse. In one example, at least one of vision recognition, user input and environment-status based prediction is employed to recognize a pest. The pest recognizing unit 100 will be described in detail with reference to FIG. 2.

In order to repel a pest, the emitting unit 200 emits an ultrasonic wave or light with a predetermined frequency bandwidth. In one embodiment, the emitting unit 200 may include either or both an ultrasonic wave emitting unit 210 and an attractant light emitting unit 220. The ultrasonic wave emitting unit 210 emits an ultrasonic wave with a frequency bandwidth detested by a pest, whereas the attractant light emitting unit 220 shed a light that a pest likes.

The ultrasonic wave emitting unit 210 may form an ultrasonic-wave curtain which makes a path toward a vent 400, so that a pest may be induced to go out of a greenhouse along the path through the vent 400. In addition, the ultrasonic wave emitting unit 210 may be installed in the surroundings of the vent 400 outside of a greenhouse, thereby preventing a pest from coming into the greenhouse through the vent 400.

In addition, the ultrasonic wave emitting unit 210 may control a single ultrasonic wave emitter to emit an ultrasonic wave with a wide frequency bandwidth. In another example, one or more ultrasonic wave emitting units 210 may be installed. That is, a plurality of ultrasonic wave emitting unit 210 may simultaneously emit ultrasonic waves with a wide frequency bandwidth, and adjust amplitude of each ultrasonic wave to make the ultrasonic waves overlap each other, resulting in the ultrasonic waves to be broadly distributed in a specific area.

The attractant light emitting unit 220 may be installed in the surrounding of one or more vents 400, and, more specifically, may be installed in the inside or outside of the one or more vents 400.

The control unit 300 detects a frequency to repel the pest recognized by the pest recognizing unit 100, and controls the emitting unit 300 to emit an ultrasonic wave or attractant light with the detected frequency.

In more detail, the control unit 300 detects a frequency which is harmful to the pest recognized by the pest recognizing unit 100, and controls the ultrasonic wave emitting unit 210 to emit an ultrasonic wave with the detected frequency. Here, the control unit 300 utilizes a stress frequency mapped to the recognized pest, by detecting the stress frequency in a stress frequency model unit 500.

The stress frequency model unit 500 includes information in which stress frequencies detested by pests are mapped. That is, the information may be a table where Identifications (IDs) are respectively assigned to various pests and stress frequencies are mapped to each ID. Here, one or more stress frequencies may be mapped to each ID.

Alternatively, the control unit 300 controls the attractant light emitting unit 220 to emit an attractant light with a frequency favored by the pest recognized by the pest recognizing unit 100. Here, the control unit 300 utilizes attractant-light frequency information mapped to the pest by detecting the attractant-light frequency information from the attractant light Database (DB) 600.

The attractant light DB 600 includes information in which attractant lights with frequencies favored by pests are mapped. That is, the information may be a table where IDs are respectively assigned to various pests and a frequency of attractant light is mapped to each ID. Here, one or more frequencies of attractant light may be mapped to each ID.

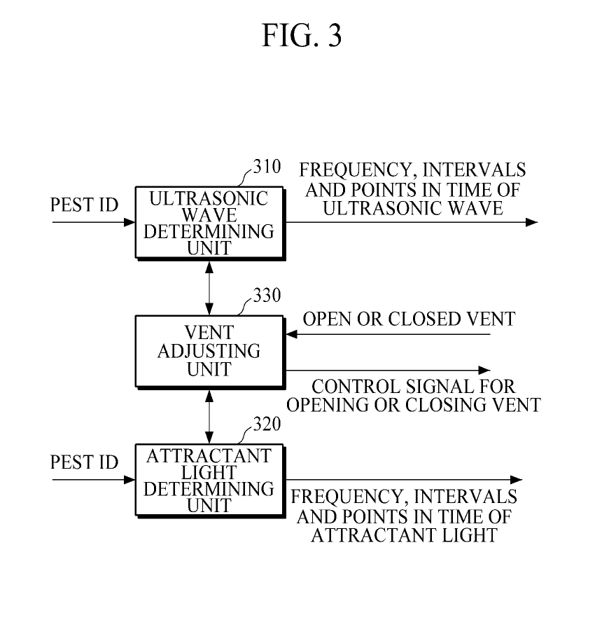

Here, either or both an ultrasonic wave and an attractant light may be emitted. The control unit 300 will be described in detail with reference to FIG. 3.

Referring to FIG. 1, one or more vents 400 may be installed in the greenhouse and may be automatically open and closed in response to control of a driving unit 410. In response to a control signal from the control unit 300, the driving unit 410 manipulates the vent 400 to be open and/or closed. in addition, the driving unit 410 informs the control unit 300 whether the vent is open or closed.

According to whether the vent 400 is open or closed, the control unit 300 activates an operation for repelling pests from a greenhouse, while controlling the vent 400 to be open in response to the activation.

FIG. 2 is a diagram illustrating a configuration of a pest recognizing unit according to an exemplary embodiment of the present invention.

Referring to FIG. 2, the pest recognizing unit 100 may includes at least one of a vision recognizing unit 110, a user input recognizing unit 120 and an environmental condition based predicting unit 130, and a pest information DB 140 and a pest identifying unit 150.

The vision recognizing unit 110 recognizes a pest, which lives in a greenhouse, using a vision recognition technology. Here, the vision recognition technology is to infer an individual object of an image by extracting features from local areas in the image and analyzing the features. Accordingly, the vision recognizing unit 110 photographs an image of the inside of the greenhouse using a camera, and infers a pest which lives in the image. Here, a pest may be inferred according to a concordance rate of the features existing in the image to predetermined features of pests.

The user input recognizing unit 120 receives user information, which includes a name and shape information of a specific pest, from a user capable of observing inside or outside of the greenhouse with eyes, and recognize a pest, which lives in or may possibly come into the greenhouse, based on the received user information. To this end, the input recognizing unit 120 may be equipped with a user input interface or receive the user information using wired/wireless communications.

The environmental condition based predicting unit 130 includes one or more sensors capable of sensing environmental conditions, such as humidity and the amount of solar radiation, and predicts a pest, which lives in or may possibly come into the greenhouse, based on the environmental conditions. Here, a pest may be inferred according to a concordance rate of the environmental conditions input from the sensors to previously-stored environmental conditions adequate for each pest to live.

The pest information DB 140 includes a pest ID required to identify a pest. The pest identification unit 150 detects a pest ID from the pest information DB 140 based on an output result from at least one of a vision recognizing unit 110, a user input recognizing unit 120 and an environmental condition based predicting unit 130. Here, the detected pest ID may be two or more.

FIG. 3 is a diagram illustrating a control unit according to an exemplary embodiment of the present invention.

Referring to FIG. 3, the control unit 300 includes at least one of an ultrasonic wave determining unit 310 and an attractant light determining unit 320, and a vent adjusting unit 330.

The ultrasonic wave determining unit 310 detects from a stress frequency model unit 200 a frequency which is mapped to a pest ID received from the pest recognizing unit 100, and transmits a control signal to an ultrasonic wave emitting unit 210 to emit an ultrasonic wave with the detected frequency. Here, the received pest ID may be two or more, so detected frequencies may be two or more. In addition, two or more frequencies may be detected with respect to a single pest ID.

In addition, the ultrasonic wave determining unit 310 determines points in time to emit an ultrasonic wave and intervals between emitting the ultrasonic wave, so that it is possible to repel a pest while preventing the pest from being resistant to the ultrasonic wave. That is, an ultrasonic wave with a frequency detested by the pest may be emitted at intervals, and thereafter the pest may be prevented from being immune or resistant to the ultrasonic wave. If the frequency is two or more, it is possible to control ultrasonic waves with two or more frequencies to be output alternatively. In addition, since there are a plurality of ultrasonic wave emitting units, an ultrasonic wave may be emitted in various ways.

The attractant light determining unit 320 detects from an attractant light DB 600 a frequency, which is mapped to the pest ID received from the pest recognizing unit 110, and transmits a control signal to request that the attractant light emitting unit 220 emit an attractant light with the detected frequency. Here, the received pest ID may be two or more, so the detected frequency may be two or more. In addition, two or more frequencies may be detected with respect to a single pest ID.

In addition, the attractant light determining unit 320 determines points in time to emit an ultrasonic wave and intervals between emitting the ultrasonic wave, and then transmits information about the points in time and the intervals to the attractant light emitting unit 220. Here, in the case of two or more frequencies, the attractant light determining unit 320 may be controlled to output ultrasonic waves with two or more frequencies alternatively.

The vent adjusting unit 330 may, according to whether the vent 400 is open or closed, adjust the activation of an operation for repelling pests from a greenhouse, or may control the vent to be open and/or closed in response to the activation of the operation for repelling pests from a greenhouse. That is, if a signal requesting to open the vent is received from a driving unit 410, there is a greater possibility of a pest coming into a greenhouse. As a result, the vent adjusting unit 330 drives either the ultrasound wave determining unit 310 or the attractant light determining unit 320, or emits an ultrasound wave or attractant light more frequently.

In addition, if the ultrasound wave determining unit 310 or the attractant light determining unit 320 is driven, the vent adjusting unit 330 may transmit to the driving unit 410 a control signal requesting to open the vent 400. In this way, a pest being under stress or tempted to move into a location indicated by the attractant light is able to go out of the greenhouse through the vent 400.

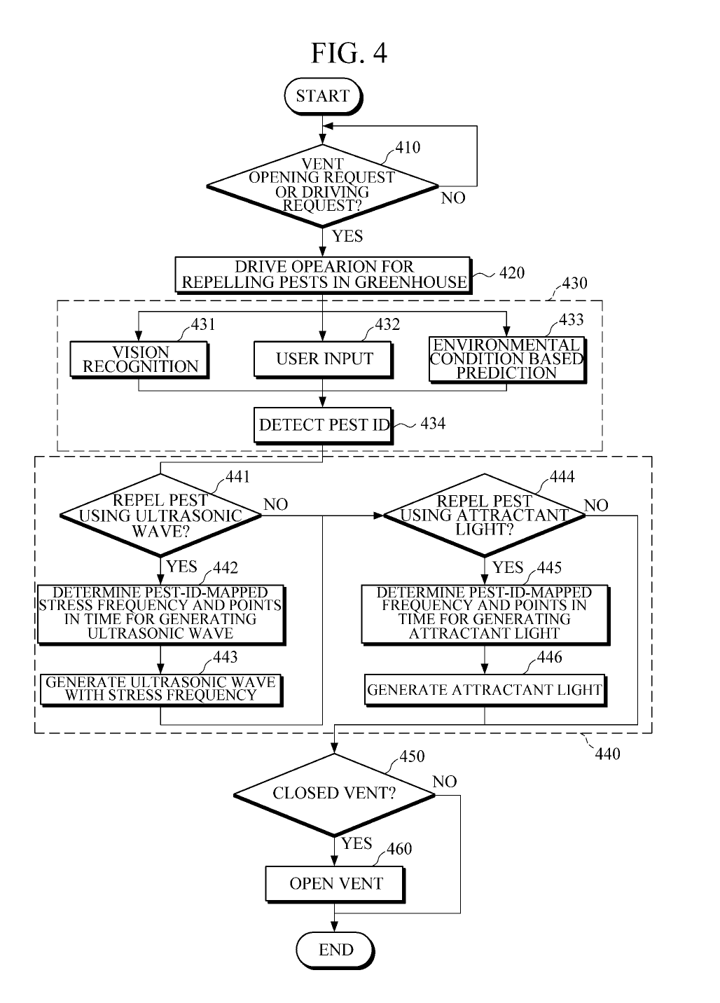

FIG. 4 is a flow chart illustrating a method for repelling pests from a greenhouse according to an exemplary embodiment of the present invention.

Referring to FIG. 4, the method for repelling pests from a greenhouse largely includes an operation 430 of recognizing a pest which lives in or may possibly come into a greenhouse, an operation 430 of detecting a frequency required to repel the recognized pest, and an operation 440 of emitting an ultrasonic wave or attractant light with the detected frequency. In addition, the method may further include operations 450 and 460 of controlling a vent.

An apparatus for repelling pests from a greenhouse determines whether an event to drive an operation for repelling pests from a greenhouse occurs in operation 410. Here, the event may include a vent opening request and a driving request. If it is determined that the event occurs, the operation for repelling pests from a greenhouse is driven in operation 420. That is, as opening a vent raises the possibility of the pest coming into the greenhouse, the apparatus for repelling pests from a greenhouse drives the operation for repelling pests from a greenhouse or emits an ultrasonic wave or attractant light more frequently.

The apparatus for repelling pests from a greenhouse recognizes a pest which lives in or may possibly come into the greenhouse in operation 430. The pest is recognized by using at least one of vision recognition 431, user input 432 and environmental condition based prediction 433.

In the vision recognition 431, the apparatus for repelling pests from a greenhouse photographs an image of the inside of the greenhouse using a camera, and infers a pest included in the image. Here, the pest may be inferred according to a concordance rate of features of the image to previously-stored features of pests.

In the user input 432, the apparatus for repelling pests from a greenhouse receives user information, which includes a name and shape information of a specific pest, from a user capable of observing the inside and outside of the greenhouse, and recognizes a pest, which lives in or may possibly come into the greenhouse, based on the received user information.

In the environmental condition based prediction 433, the apparatus for repelling pests from a greenhouse senses environmental conditions, such as humidity and the amount of solar radiation, and predicts a pest, which lives in or may possibly come into the greenhouse, based on the sensed environmental conditions. Here, the pest may be inferred according to a concordance rate of the environmental conditions received from sensors to predetermined environmental conditions of pest habitat.

The apparatus for repelling pests from a greenhouse detects a pest ID based on an output result from at least one of the vision recognition 431, the user input 432 and the prediction 433. Here, the detected pest ID may be two or more.

The apparatus for repelling pests from a greenhouse emits an ultrasonic wave or light with a specific frequency which is effective in repelling pests in operation 440. The apparatus may emit an ultrasonic wave or light with a specific frequency detected by a pest in operation 441 or 443, or may emit an attractant light with a specific frequency favored by a pest in operation 444 or 446. Alternatively, the apparatus for repelling pests from a greenhouse may be able to perform the above-mentioned operations 441, 443, 444 and 446.

The apparatus for repelling pests from a greenhouse determines whether to repel the pest using an ultrasonic wave in operation 441. If it is determined to repel the pest using an ultrasonic wave, the apparatus performs operations 442 and 443.

The apparatus for repelling pests from a greenhouse detects a frequency, which is mapped to the detected pest ID, from a stress frequency model unit 200 and determines points in time to emit an ultrasonic wave in operation 442. Here, since the pest ID may be two or more, the detected frequency may be two or more. In addition, two or more frequencies may be mapped to each pest ID. In the case of two or more frequencies, the apparatus may control to output ultrasonic waves with two or more frequencies alternatively. In addition, since there are a plurality of ultrasonic wave emitting units, an ultrasonic wave may be emitted in various ways. Here, the apparatus may determine intervals between emitting the ultrasonic wave, so that it is possible to emit the ultrasonic wave with a frequency detested by the pest at intervals while preventing the pest from being immune or resistant to the ultrasonic wave. The apparatus emits an ultrasonic wave with the detected frequency in operation 443.

Meanwhile, if it is determined in operation 441 not to repel the pest using an ultrasonic wave, the apparatus determines whether to repel the pest using an attractant light in operation 441. If it is determined in operation 441 not to repel the pest using an attractant light, the apparatus performs operations 445 and 446.

The apparatus detects from an attractant frequency DB 200 a frequency mapped to the detected pest ID, and determines points in time to emit the attractant light in operation 444. Here, the pest ID may be two or more, so the detected frequency may be two or more. In addition, two or more frequencies may be detected with respect to each pest ID. The apparatus determines points in time to emit an ultrasonic wave and intervals between emitting the ultrasonic wave. The apparatus emits an attractant light with the detected frequency. Here, in the case of two or more frequencies, the apparatus may control to output ultrasonic waves with the two or more frequencies alternatively.

If it is determined in operation 444 not to repel the pest using an attractant light, the apparatus performs operation 450.

In response to at least one of an ultrasonic wave or attractant light emitted in the above-mentioned operations, the apparatus determines whether the vent is closed in operation 450.

If it is determined in operation 450 that the vent is closed, the apparatus opens the closed vent in operation 460. As a result, a pest being under stress or tempted to move into a place shed by the attractant light is able to escape the greenhouse through the vent 400.

The above-described apparatus for repelling pests from a greenhouse is able to recognize a pest which lives in or may possibly come into a greenhouse, and to utilize an appropriate method for repelling the recognized pest, so that it may require less effort to detect pests in a greenhouse.

In addition, the above-mentioned apparatus is able to repel the recognized pest by emitting an stress ultrasonic wave or attractant light adequate for the pest, so that it may prevent food contamination and environmental devastation caused by use of pesticide.

In addition, the above-mentioned apparatus is able to emit an ultrasonic wave or attractant light more frequently in accordance with openness and/or closeness of a vent of a greenhouse, and to control to open and/or close the vent in response to the emitted ultrasonic wave or attractant light, thereby enhancing efficiency in repelling pests.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method for repelling pests in an apparatus installed in a greenhouse which is open and closed by a vent, the method comprising:
recognizing a pest which lives in or may possibly come into a greenhouse, detecting a frequency required to repel the recognized pest; and
emitting an ultrasonic wave or attractant light with the detected frequency.

2. The method of claim 1, wherein the recognizing of the pest comprises inferring the pest by analyzing an image of the inside of the greenhouse.

3. The method of claim 1, wherein the recognizing of the pest comprises recognizing a specific pest based on user information, comprising a name and shape information of the specific pest, which is received from a user capable of observing the inside and outside of the greenhouse.

4. The method of claim 1, wherein the recognizing of the pest comprises predicting a pest, which lives in or may possibly come into the greenhouse, based on environmental conditions comprising humidity and an amount of solar radiation.

5. The method of claim 1, wherein the frequency is at least one of a stress ultrasonic wave frequency harmful to the recognized pest and an attractant frequency favored by the recognized pest.

6. The method of claim 1, further comprising, prior to the recognizing of the pest, determining whether the vent of the greenhouse is open or closed,
wherein, if it is determined that the vent is open, the recognizing of the pest or the emitting of the ultrasonic wave or attractant light is performed more frequently.

7. The method of claim 1, further comprising, in concurrence with the emitting of the ultrasonic wave or attractant light, determining whether the vent is open or closed; and
wherein, if it is determined that the vent is closed, the vent is controlled to be open.

8. An apparatus for repelling pests from a greenhouse, the apparatus comprising:
is a pest recognizing unit configured to recognize a pest which lives in or may possibly come into a greenhouse which is open and closed by a vent;
an emitting unit; and
a control unit configured to detect a frequency required to repel the recognized pest, and control the emitting unit to emit an ultrasonic wave or attractant light with the detected frequency.

9. The apparatus of claim 8, wherein the pest recognizing unit comprises
a vision recognizing unit configured to infer the pest by analyzing an imaging of the inside of the greenhouse; and
an identifying unit configured to detect a pest ID corresponding the pest inferred by the vision recognizing unit.

10. The apparatus of claim 8, wherein the pest recognizing unit comprises
a user input recognizing unit configured to receive user information, comprising a name and shape information of a specific pest, from a user who is capable of observing an inside or outside of the greenhouse with eyes; and
an identifying unit configured to detect a pest ID corresponding to the user information input by the user input recognizing unit.

11. The apparatus of claim 8, wherein the pest recognizing unit comprises
an environmental condition based predicting unit configured to predict a pest according to environmental conditions such as humidity and an amount of solar radiation; and
an identifying unit configured to detect a pest ID corresponding to the pest predicted by the environmental condition based predicting unit.

12. The apparatus of claim 8, wherein the emitting unit comprises
at least one of an ultrasonic wave emitting unit emitting an ultrasonic wave with a predetermined frequency; and
an attractant light emitting unit emitting attractant light with a predetermined frequency,
wherein the control unit controls the ultrasonic wave emitting unit to emit a ultrasonic wave with a frequency harmful to the recognized pest or control the attractant light emitting unit to emit an attractant light with a frequency favored by the recognized pest.

13. The apparatus of claim 12, further comprising a stress frequency model unit configured to store stress frequencies on the basis of pest,
wherein the control unit detects a stress frequency mapped to the recognized pest from the stress frequency model unit.

14. The apparatus of claim 8, further comprising a driving unit configured to notify whether the vent is open or closed,
wherein, if it is determined in the driving unit that the vent is open, the control unit recognizes the pest more frequently or emits the ultrasonic wave or attractant light with the frequency more frequently.

15. The apparatus of claim 8, further comprising a driving unit configured to open or close the vent,
wherein, in concurrent with the emitting of the ultrasonic wave or attractant light, the control unit transmits a control signal to the driving unit to open the vent.
